(19) United States
(12) Patent Application Publication
(10) Pub. No.: US 2013/0330480 A1
(43) Pub. Date: Dec. 12, 2013

(54) LIQUID-APPLICATION DEVICE AND LIQUID-APPLICATION METHOD

(71) Applicants: Masaru Nonomura, Osaka (JP); Seikou Abe, Osaka (JP)

(72) Inventors: Masaru Nonomura, Osaka (JP); Seikou Abe, Osaka (JP)

(73) Assignee: PANASONIC CORPORATION, Osaka (JP)

(21) Appl. No.: 14/000,768

(22) PCT Filed: Mar. 13, 2012
(86) PCT No.: PCT/JP2012/001712

§ 371 Date: Aug. 21, 2013

(30) Foreign Application Priority Data
Aug. 30, 2011 (JP) 2011-187211

(51) Int. Cl. B05C 13/00

(52) U.S. Cl. CPC B05C 13/00
USPC 427/421.1; 118/300

(57) ABSTRACT

In the liquid application device 1, when the magazine 5 for feeding the substrate installed in the substrate feed part is exchanged for a new magazine 5 for feeding the substrate, the magazine 5 for collecting the substrate is removed from the substrate collecting part R2, the magazine 5 for feeding the substrate that is installed in the substrate feed part R1 so far is moved to the substrate collecting part R2 as a subsequently used magazine 5 for collecting the substrate, and then, the new magazine 5 for feeding the substrate is installed in the substrate feed part R1.

### BACKGROUND OF THE INVENTION

1. Technical Field

The present invention relates to a liquid-application device and a liquid-application method which applies a liquid such as a resin on a substrate.

2. Background Art

Usually, a liquid-application device known as a device for applying a liquid such as a resin to a substrate or parts on the substrate takes out the substrate before the liquid is applied from a magazine for feeding the substrate to convey the substrate to a working position, applies the liquid to the substrate in the working position, and then, conveys the substrate from the working position to accommodate the substrate in a magazine for collecting the substrate. Here, a substrate feeding part in which the magazine for feeding the substrate is installed and a substrate collecting part in which the magazine for collecting the substrate is installed are provided at positions opposed to each other with the working position where the liquid is applied to the substrate sandwiched between them. After the liquid is applied to the substrate taken out from the magazine for feeding the substrate in the working position, the substrate is conveyed in the same direction as that when the substrate is conveyed to the working position from the magazine for feeding the substrate and accommodated in the magazine for collecting the substrate (for instance, patent literature 1).

### LITERATURE OF RELATED ART

### Patent Literature

Patent Literature 1: Japanese Patent No. 4373041

### SUMMARY OF THE INVENTION

### Problems that the Invention is to Solve

However, in the above-described usual liquid application device, when all the substrates are taken out from the magazine for feeding the substrate which is installed in the substrate feed part so that the magazine for feeding the substrate needs to be exchanged for a new magazine for feeding the substrate, not only a work for removing the magazine for collecting the substrate in which the substrates after the liquid-application is applied are accommodated from the substrate collecting part and a work for installing the new magazine for feeding the substrate in which the substrates before the liquid-application is applied are accommodated in the substrate feed part need to be carried out, but also a work for carrying the magazine for feeding the substrate which is installed in the substrate feed part so far outside the device (the liquid application device) and a work for carrying the new magazine for collecting the substrate to the device need to be carried out. Thus, a problem arises that a moving mechanism of the magazine is complicated, so that a production cost of the device is the higher.

Thus, it is an object of the present invention to provide a liquid application device and a liquid-application method which can simplify a moving mechanism of a magazine and reduce a production cost.

### Means for Solving the Problems

A liquid application device of the present invention includes a substrate feed part where a magazine for feeding a substrate is installed in which the substrates before a liquid-application is applied are accommodated, an application head which applies the liquid-application to the substrate taken out from the magazine for feeding the substrate installed in the substrate feed part and moved to a working position and a substrate collecting part where a magazine for collecting the substrate is installed in which the substrates with the liquid-application applied by the application head are accommodated. In the liquid application device, a magazine moving unit is provided which removes the magazine for collecting the substrate from the substrate collecting part, when the magazine for feeding the substrate installed in the substrate feed part is exchanged for a new magazine for feeding the substrate, moves the magazine for feeding the substrate that is installed in the substrate feed part so far to the substrate collecting part as a subsequently used magazine for collecting the substrate, and then, installs the new magazine for feeding the substrate in the substrate feed part.

A liquid-application method of the present invention includes a step in which a substrate before a liquid is applied is taken out from a magazine for feeding the substrate installed in a substrate feed part and moved to a working position, a step in which the liquid is applied to the substrate moved to the working position, and a step in which the substrate to which the liquid is applied is moved from the working position to accommodate the substrate in a magazine for collecting the substrate installed in a substrate collecting part. In the liquid-application method, when the magazine for feeding the substrate installed in the substrate feed part is exchanged for a new magazine for feeding the substrate, the magazine for collecting the substrate is removed from the substrate collecting part, the magazine for feeding the substrate that is installed in the substrate feed part so far is moved to the substrate collecting part as a subsequently used magazine for collecting the substrate, and then, the new magazine for feeding the substrate is installed in the substrate feed part.

### Advantage of the Invention

In the present invention, when the magazine for feeding the substrate installed in the substrate feed part is exchanged for a new magazine for feeding the substrate, the magazine for collecting the substrate is removed from the substrate collecting part, the magazine for feeding the substrate that is installed in the substrate feed part so far is moved to the substrate collecting part as a subsequently used magazine for collecting the substrate, and then, the new magazine for feeding the substrate is installed in the substrate feed part. Accordingly, since the magazine for feeding the substrate that is installed in the substrate feed part so far is used as the magazine for collecting the substrate, the work for carrying the magazine for feeding the substrate which is installed in the substrate feed part so far outside the device and the work for carrying the new magazine for collecting the substrate to the device are not necessary. Thus, the number of setting steps of empty magazines necessary for a usual loader and un-loader type can be reduced, so that a production cost can be the more reduced.

### BRIEF DESCRIPTION OF THE DRAWINGS

FIG. 1 is a perspective view of a liquid-application device in one exemplary embodiment of the present invention.

FIG. 2 is a perspective view of a main body part of the liquid-application device in the one exemplary embodiment of the present invention.

FIG. 3 is a perspective view of a substrate feed and collecting part of the liquid-application device in the one exemplary embodiment of the present invention.

FIG. 4 is a front view of the substrate feed and collecting part of the liquid-application device of the one exemplary embodiment of the present invention.

FIG. 5 is a perspective view showing a magazine together with a substrate in the one exemplary embodiment of the present invention.

FIG. 6 is view in which (a) and (b) are front views of a part of a magazine moving mechanism provided in the substrate feed and collecting part in the one exemplary embodiment of the present invention.

FIG. 7 is view in which (a) and (b) are front views of a part of the magazine moving mechanism provided in the substrate feed and collecting part in the one exemplary embodiment of the present invention.

FIG. 8 is a block diagram showing a control system of the liquid-application device in the one exemplary embodiment of the present invention.

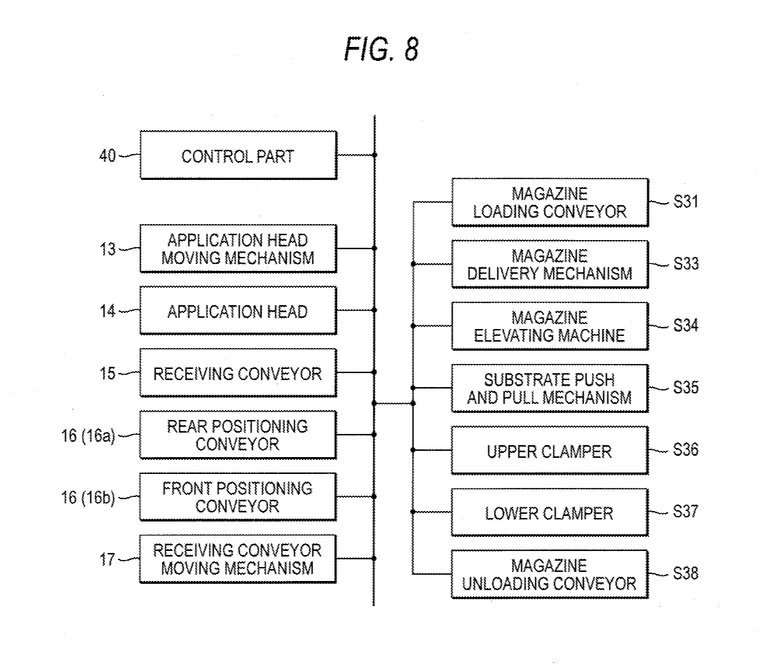

FIG. 9 is view in which (a), (b), (c) and (d) are operation explaining diagrams of the liquid-application device in the one exemplary embodiment of the present invention.

FIG. 10 is view in which (a), (b), (c) and (d) are operation explaining diagrams of the liquid-application device in the one exemplary embodiment of the present invention.

FIG. 11 is view in which (a), (b), (c) and (d) are operation explaining diagrams of the liquid-application device in the one exemplary embodiment of the present invention.

FIG. 12 is view in which (a), (b), (c) and (d) are operation explaining diagrams of the liquid-application device in the one exemplary embodiment of the present invention.

FIG. 13 is view in which (a), (b), (c) and (d) are operation explaining diagrams of the liquid-application device in the one exemplary embodiment of the present invention.

### MODE FOR CARRYING OUT THE INVENTION

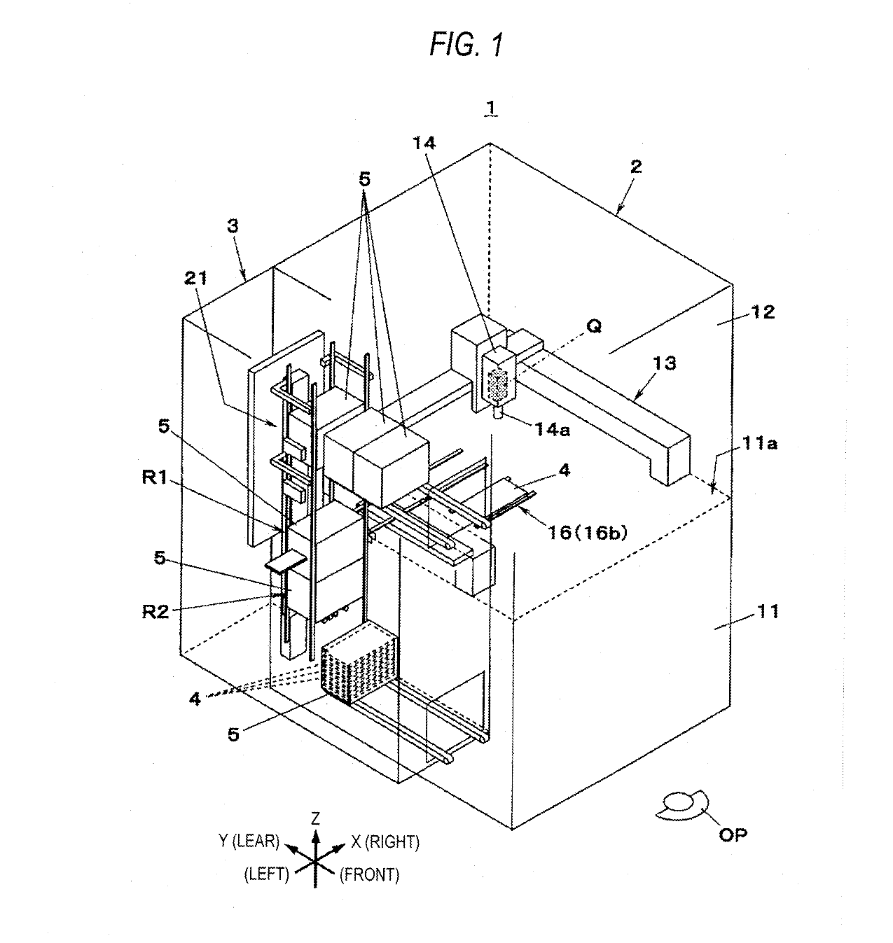

Now, by referring to the drawings, an exemplary embodiment of the present invention will be described below A liquid-application device 1 shown in FIG. 1 includes a main body part 2 and a substrate feed and collecting part 3. The main body part 2 feeds a liquid such as a resin to a fed substrate 4 (or parts provided on the substrate 4 which are not shown in the drawing). The substrate feed and collecting part 3 feeds the substrate 4 before the liquid is applied to the main body part 2 and collects the substrate 4 after the liquid is applied in the main body part 2. As described below, the substrate feed and collecting part 3 feeds the substrate 4 to the main body part 2 and collects the substrate 4 from the main body part 2 through a magazine 5 in which a plurality of substrate 4 are arranged and accommodated in parallel in a vertical direction. In an explanation described below, a direction where the main body part 2 and the substrate feed and collecting part 3 are arranged is set to an X-axis direction. A direction in a horizontal plane which intersects at right angles to the X-axis direction is set to a Y-axis direction. A vertical direction is set to a Z-axis direction. Further, in a transverse direction (the X-axis direction), a left side (a side in which the substrate feed and collecting part 3 is provided) seen from an operator OP is defined as a left part. A right side seen from the operator OP is defined as a right part. Further, a front side seen from the operator OP is defined as a front part and an interior side seen from the operator OP is defined as a rear part.

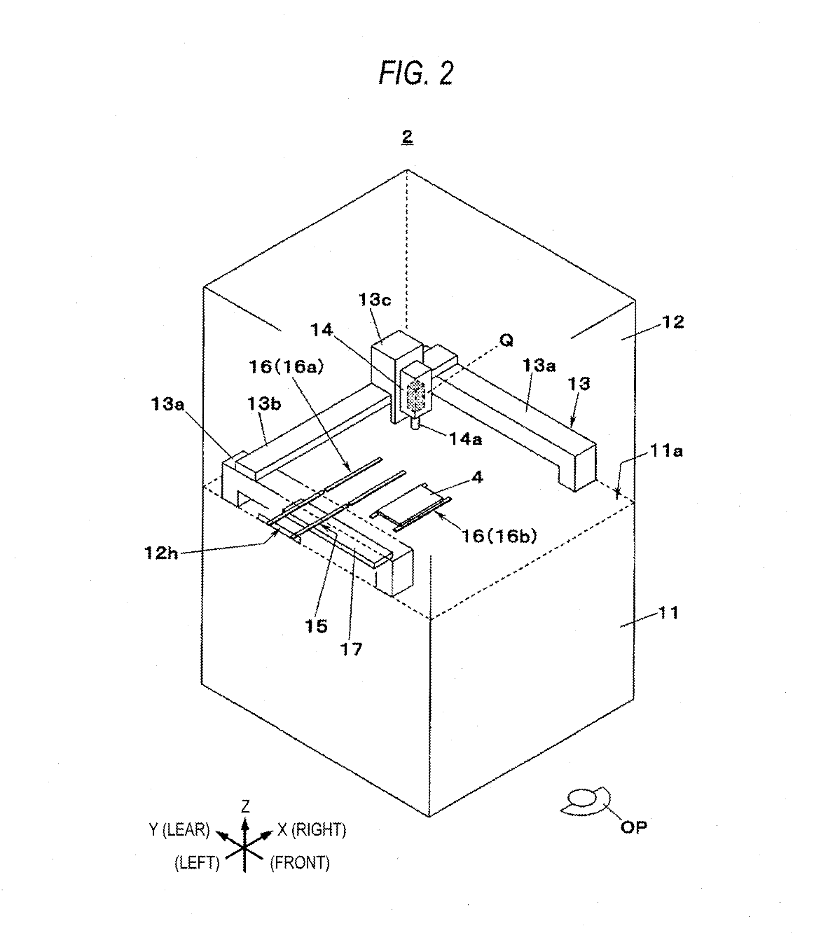

In FIG. 2, the main body part 2 includes a base part 11 having a flat working plane 11a and a cover part 12 provided to cover an upper space of the working plane 11a of the base part 11. On the working plane 11a of the base part 11, an application head moving mechanism 13, is provided, including a pair of Y-axis tables 13a which extend in the Y-axis direction and are opposed to the X-axis direction (the transverse direction), an X-axis table 13b which extends in the X-axis direction and has both ends supported by the one pair of Y-axis tables 13a and a moving stage 13c provided so as to be movable in the X-axis direction along the X-axis table 13b. To the moving stage 13c of the application head moving mechanism 13, an application head 14 is attached.

In the application head moving mechanism 13, a movement of the X-axis table 13b in the Y-axis direction relative to the one pair of Y-axis tables 13a is combined with a movement of the moving stage 13c in the X-axis direction relative to the X-axis table 13b to move the application head 14 in a horizontal plane. The application head 14 accommodates therein the liquid Q such as the resin and discharges the accommodated liquid Q downward from an end part of an application nozzle 14a which extends downward.

In a left area of the working plane 11a, a receiving conveyor 15 is provided which receives the substrate 4 fed from the substrate feed and collecting part 3. In a central part of the working plane 11a of the base part 11, two positioning conveyors 16 (a rear positioning conveyor 16a located in the rear part and a front positioning conveyor 16b located in the front part) are provided and arranged in the Y-axis direction (forward and backward).

The receiving conveyor 15 and the two positioning conveyors 16 are respectively attached in such positions as to convey the substrate 4 in the X-axis direction. The receiving conveyor 15 is moved in the Y-axis direction by a receiving conveyor moving mechanism 17 provided on the working plane 11a of the base part 11 and is allowed to selectively face one of the two positioning conveyors 16 in the X-axis direction.

In a side surface of the left side of the cover part 12, a substrate passage opening 12h is provided for allowing the substrate 4 to pass between the side surface and the substrate feed and collecting part 3. The receiving conveyor 15 receives the substrate 4 fed through the substrate passage opening 12h from the magazine 5 for feeding the substrate (the magazine 5 in which the substrates 4 before the liquid Q is applied are accommodated) which is installed in the substrate feed and collecting part 3 and delivers the substrate to the rear positioning conveyor 16a or the front positioning conveyor 16b. Then, the rear positioning conveyor 16a positions the substrate 4 received from the receiving conveyor 15 on a working position (refer it to as a rear working position) set on the rear positioning conveyor 16a. The front positioning conveyor 16b positions the substrate 4 received from the receiving conveyor 15 on a working position (refer it to as a front working position) set on the front positioning conveyor 16b. Further, the rear positioning conveyor 16a receives the substrate 4 in which an applying operation of the liquid Q is finished by the application head 14 and delivers the substrate to the receiving conveyor 15. Further, the front positioning conveyor 16b receives the substrate 4 in which an applying operation of the liquid Q is finished by the application head 14 and delivers the substrate to the receiving conveyor 15. The receiving conveyor 15 delivers the substrate 4 received from the rear positioning conveyor 16a or the front positioning conveyor 16b to the magazine 5 for collecting the substrate (the magazine 5 in which the substrates 4 after the liquid Q is applied are accommodated) installed in the substrate feed and collecting part 3.

Namely, the liquid-application device 1 in the present exemplary embodiment has the two working positions. The receiving conveyor 15 and the two positioning conveyors 16 (the rear positioning conveyor 16a and the front positioning conveyor 16b) move the substrate 4 taken out from the magazine 5 for feeding the substrate to the working position and move the substrate 4 to which the liquid Q is applied in the working position to the magazine 5 for collecting the substrate 4. The application head 14 applies the liquid Q to the substrate 4 taken out from the magazine 5 for feeding the substrate and moved (positioned) to the rear working position by the rear positioning conveyor 16a or to the front working position by the front positioning conveyor 16b.

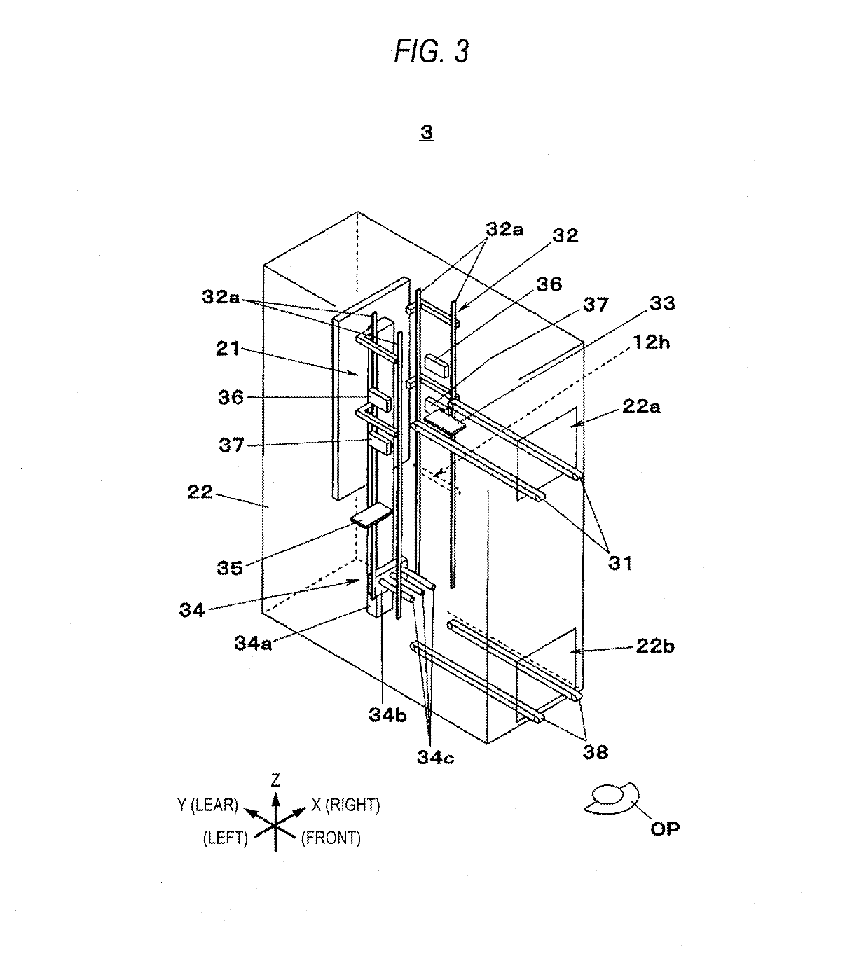

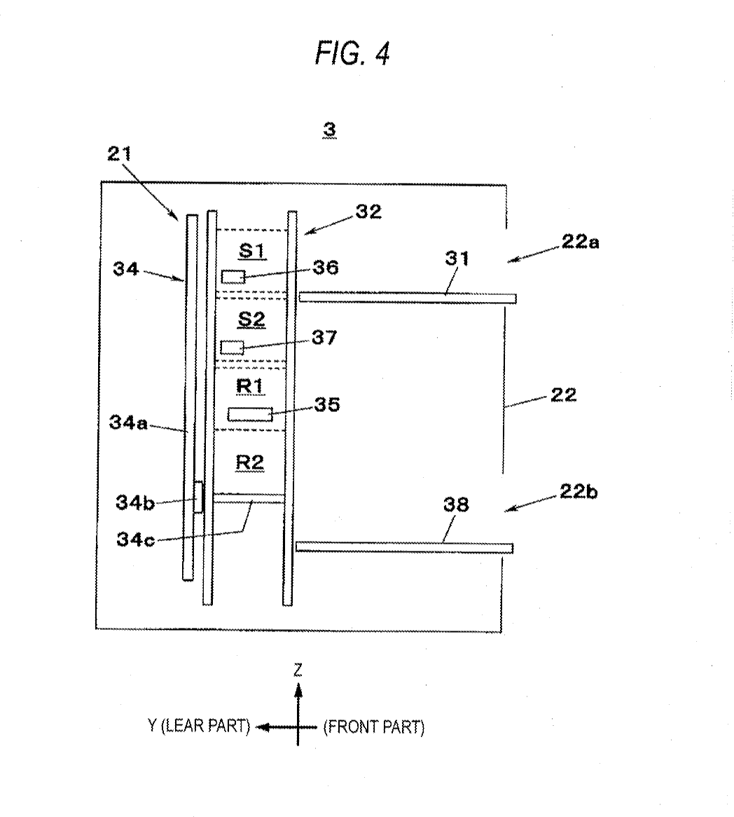

In FIG. 3 and FIG. 4, the substrate feed and collecting part 3 has a magazine moving mechanism 21 which moves the magazine 5 and a cover member 22 attached to a side surface of the left side of the main body part 2 and opened to the right side which covers an entire part of the magazine moving mechanism 21.

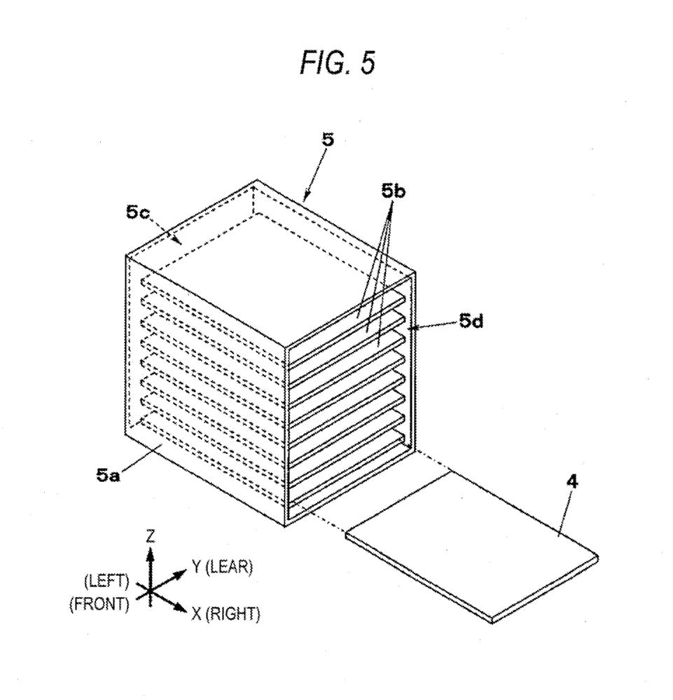

Each of the magazines 5 moved by the magazine moving mechanism 21 includes, as shown in FIG. 5, an outer shell part 5a having a form passing through in the transverse direction (the X-axis direction) under a state that the magazine is installed in the substrate feed and collecting part 3 and a plurality of rack parts 5b provided to be arranged in parallel in the vertical direction in the outer shell part 5a. In the rack parts 5b, the substrates 4 are respectively mounted and accommodated. Under a state that the magazine 5 is installed in the substrate feed and collecting part 3, when the substrate 4 is pushed by a below-described substrate push and pull mechanism 35 of the magazine moving mechanism 21 from a rear surface opening 5c of the left side to a front surface opening 5d of the right side, the substrate 4 can be fed to the main body part 2 side from the front surface opening 5d. When the substrate 4 located in the front surface opening 5d side is pulled from the rear surface opening 5c side by the substrate push and pull mechanism 35, the substrate 4 can be accommodated on the rack part 5b.

In FIG. 3 and FIG. 4, the magazine moving mechanism 21 includes a magazine loading conveyor 31, a magazine guide 32, a magazine delivery mechanism 33, a magazine elevating machine 34, the substrate push and pull mechanism 35, an upper clamper 36, a lower clamper 37 and a magazine unloading conveyor 38.

In FIG. 3 and FIG. 4, the magazine loading conveyor 31 conveys the magazine 5 for feeding the substrate in which the substrates 4 before the liquid Q is applied are accommodated from the front part to the rear part (toward an upper part of the magazine guide 32). On an upper part of the front surface of the cover member 22, a magazine taking-in opening 22a is provided. A front end part of the magazine loading conveyor 31 is located to come into close contact with the magazine taking-in opening 22a.

Here, as a device which conveys the magazine 5 for feeding the substrate in which the substrates 4 before the liquid is applied are accommodated from the front part to the rear part, the conveyor (the magazine loading conveyor 31) is used, however, a pushing mechanism using a cylinder may be used.

In FIG. 3 and FIG. 4, the magazine guide 32 includes four guide members 32a extending in the Z-axis direction to support four corners of the magazine 5 and guide a movement of the magazine 5 in the vertical direction.

In FIG. 3, the magazine delivery mechanism 33 supports from a lower part the magazine 5 conveyed to a position near an upper part (a rear end part of the magazine loading conveyor 31) of the magazine guide 32 by the magazine loading conveyor 31, moves the magazine 5 rearward and delivers the magazine 5 to the magazine guide 32.

In FIG. 3 and FIG. 4, the magazine elevating machine 34 includes an elevating mechanism part 34a provided to extend in the vertical direction in a rear part of the magazine guide 32 and an elevating part 34b moved in the vertical direction by the elevating mechanism part 34a. The elevating part 34b has a plurality of post shaped magazine support parts 34c which protrude and extend forward. Under a state that the plurality of magazine support parts 34c is allowed to come into contact with the magazine 5 in the magazine guide 32 from a lower part, the elevating part 34b is moved in the vertical direction by the elevating mechanism part 34a. Thus, the magazine 5 directly supported by the elevating part 34b (and other magazine 5 mounted on an upper surface of the magazine 5) can be elevated or lowered along the magazine guide 32.

In FIG. 4, in a moving area of the magazine 5 in the vertical direction by the magazine guide 32, an area for one magazine 5 located at the same height as that of the magazine 5 conveyed from the front part to the rear part by the magazine loading conveyor 31 is set to a first magazine holding area S1 where the magazine 5 conveyed by the magazine loading conveyor 31 is held. An area for one magazine 5 located directly below the first magazine holding area S1 is set to a second magazine holding area S2 where the magazine 5 held in the first magazine holding area S1 is subsequently temporarily held. Further, in FIG. 4, an area occupied by the magazine 5 of an upper side of the two magazines 5 piled in the vertical direction which are elevated or lowered by the magazine elevating machine 34 is set to a substrate feed part R1 in which the magazine 5 for feeding the substrate is installed. An area occupied by the magazine 5 of a lower side of the two magazines 5 piled in the vertical direction which are elevated or lowered by the magazine elevating machine 34 is set to a substrate collecting part R2 in which the magazine 5 for collecting the substrate is installed.

As described above, in the liquid-application device 1, the substrate feed part R1 in which the magazine 5 for feeding the substrate is installed and the substrate collecting part R2 in which the magazine 5 for collecting the substrate are arranged and located in the vertical direction. The magazine elevating machine 34 as a magazine elevating unit elevates or lowers at the same time the magazine 5 for feeding the substrate of the substrate feed part R1 and the magazine 5 for collecting the substrate of the substrate collecting part R2 to position the magazine 5 for feeding the substrate in the vertical direction when the substrate 4 is taken out and position the magazine 5 for collecting the substrate in the vertical direction when the substrate 4 is collected.

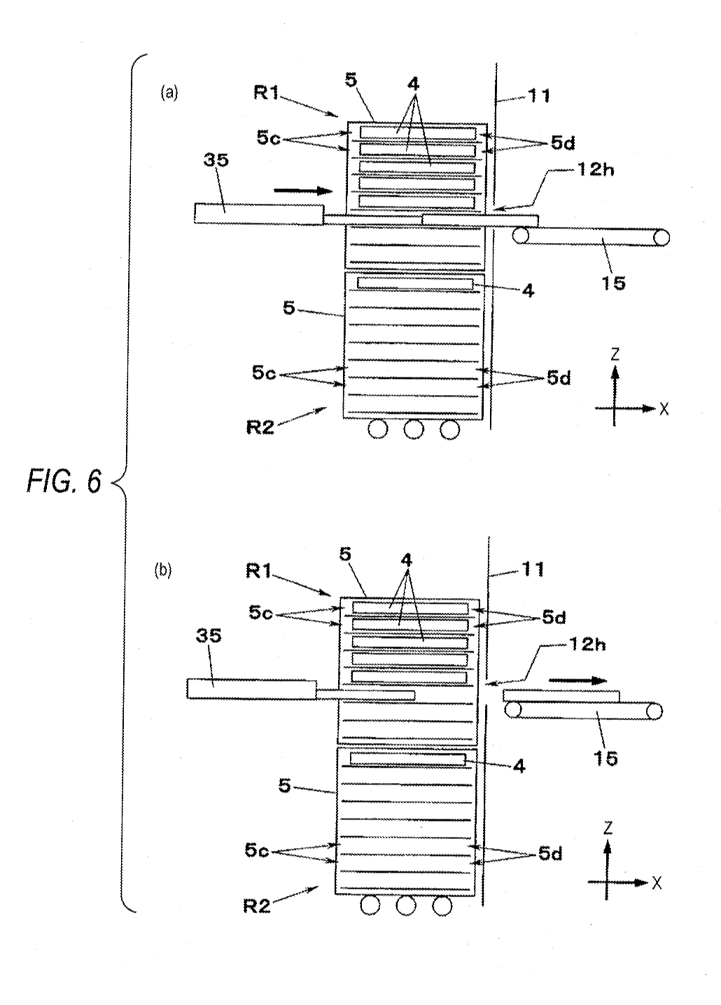

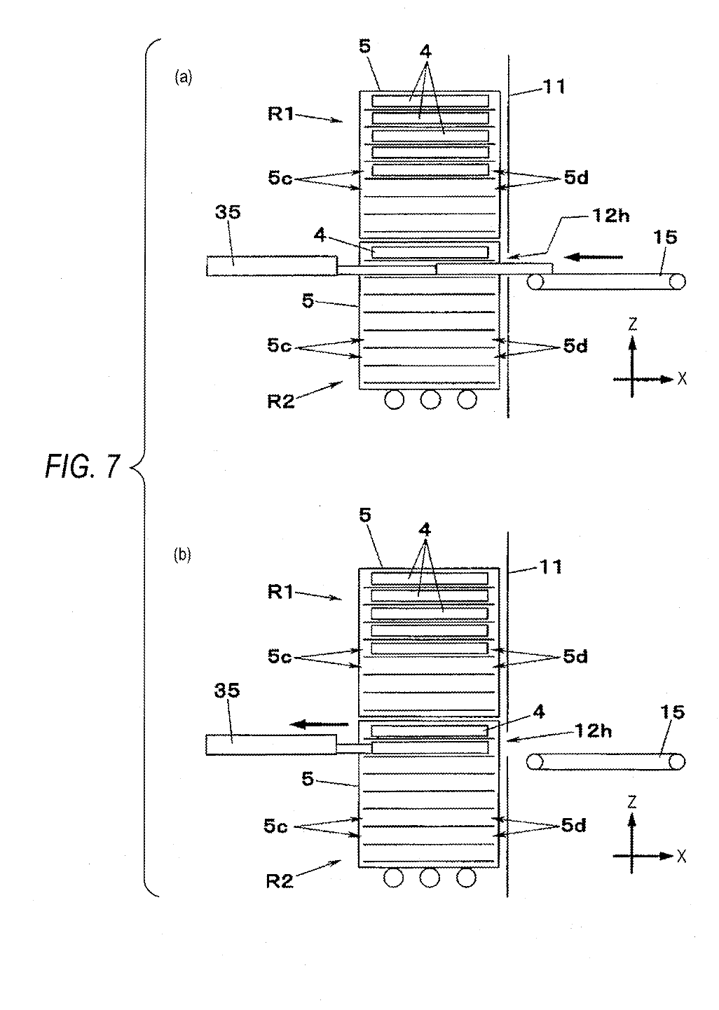

In FIG. 3 and FIG. 4, the substrate push and pull mechanism 35 is provided in the left position of an intermediate part in the vertical direction of the magazine guide 32. Under a state that one of the plurality of rack parts 5b provided in the magazine 5 for feeding the substrate which is elevated or lowered by the magazine elevating machine 34 corresponds to the substrate passage opening 12h of the main body part 2 side, is carried out a substrate feeding operation ((a) to (b) in FIG. 6) that the substrate 4 in the rack part 5b (the substrate 4 before the liquid is applied) is pushed out from the rear surface opening 5c side to the front surface opening 5d side to feed the substrate 4 to the receiving conveyor 15 of the main body part 2. Further, under a state that one of the plurality of rack parts 5b provided in the magazine 5 for collecting the substrate which is elevated or lowered by the magazine elevating machine 34 corresponds to the substrate passage opening 12h of the main body part 2 side, is carried out a substrate accommodating operation ((a) to (b) in FIG. 7) that the substrate 4 (the substrate 4 after the liquid is applied) fed to the front surface opening 5d side from the receiving conveyor 15 of the main body part 2 is pulled from the rear surface opening 5c side to mount the substrate on the rack part 5b provided in the magazine 5 for collecting the substrate.

Here, when the substrate 4 fed to the front surface opening 5d from the receiving conveyor 15 of the main body part 2 is accommodated in the magazine 5 for collecting the substrate, the substrate push and pull mechanism 35 pulls the substrate 4 on the receiving conveyor 15 to the magazine 5 for collecting the substrate. However, the substrate 4 on the receiving conveyor 15 may be pushed in by a substrate pushing mechanism provided in a lower part of the receiving conveyor 15 and accommodated in the magazine 5 for collecting the substrate.

In FIG. 3 and FIG. 4, the upper clamper 36 is formed with one pair of members opposed to each other in the transverse direction (the X-axis direction) with the first magazine holding area S1 in the magazine guide 32 sandwiched between them to clamp and hold in the X-axis direction the magazine 5 delivered to the first magazine holding area S1 in the magazine guide 32 by the magazine delivery mechanism 33.

In FIG. 3 and FIG. 4, the lower clamper 37 is formed with one pair of members opposed to each other in the transverse direction (the X-axis direction) with the second magazine holding area S2 in the magazine guide 32 sandwiched between them to clamp and hold in the X-axis direction the magazine 5 lowered from the first magazine holding area S1 by the magazine elevating machine 34 and located in the second magazine holding area S2.

In FIG. 3 and FIG. 4, the magazine unloading conveyor 38 conveys the magazine 5 for collecting the substrate in which the substrates 4 after the liquid is applied are accommodated in a horizontal direction from a lower part of the magazine guide 32 to the front part. In a lower part of the front surface of the cover member 22, a magazine taking-out opening 22b is provided. A front end part of the magazine unloading conveyor 38 is located to come into close contact with the magazine taking-out opening 22b.

Here, as a device by which the magazine 5 for collecting the substrate in which the substrates 4 after the liquid is applied is accommodated is conveyed from the lower part of the magazine guide 32 to the front part, the conveyor (the magazine unloading conveyor 38) is used, however, a pushing mechanism using a cylinder may be employed.

A control of a moving operation of the application head 14 in the direction of the horizontal plane by the application head moving mechanism 13 provided in the main body part 2, a control of a discharging operation of the liquid Q by the application head 14, a control of the conveying operation of the substrate 4 by the receiving conveyor 15, a control of the conveying operation of the substrate 4 to the rear working position by the rear positioning conveyor 16a, a control of the conveying operation of the substrate 4 to the front working position by the front positioning conveyor 16b and a control of a moving operation of the receiving conveyor 15 in the Y-axis direction by the receiving conveyor moving mechanism 17 are carried out by a controller 40 provided in the liquid-application device 1 (FIG. 4).

Further, a control of the conveying operation of the magazine 5 for feeding the substrate by the magazine loading conveyor 31 provided in the substrate feed and collecting part 3, a control of a moving operation of the magazine 5 to the first magazine holding area S1 by the magazine delivery mechanism 33, a control of an elevating or lowering operation of the magazine 5 by the magazine elevating machine 34, a control of the substrate feeding operation and the substrate accommodating operation by the substrate push and pull mechanism 35, a control of clamping and unclamping operations of the magazine 5 located in the first magazine holding area S1 by the upper clamper 36, a control of damping and unclamping operations of the magazine 5 located in the second magazine holding area S2 by the lower clamper 37 and a control of the conveying operation of the magazine 5 for collecting the substrate by the magazine unloading conveyor 38 are also carried out by the controller 40 (FIG. 4).

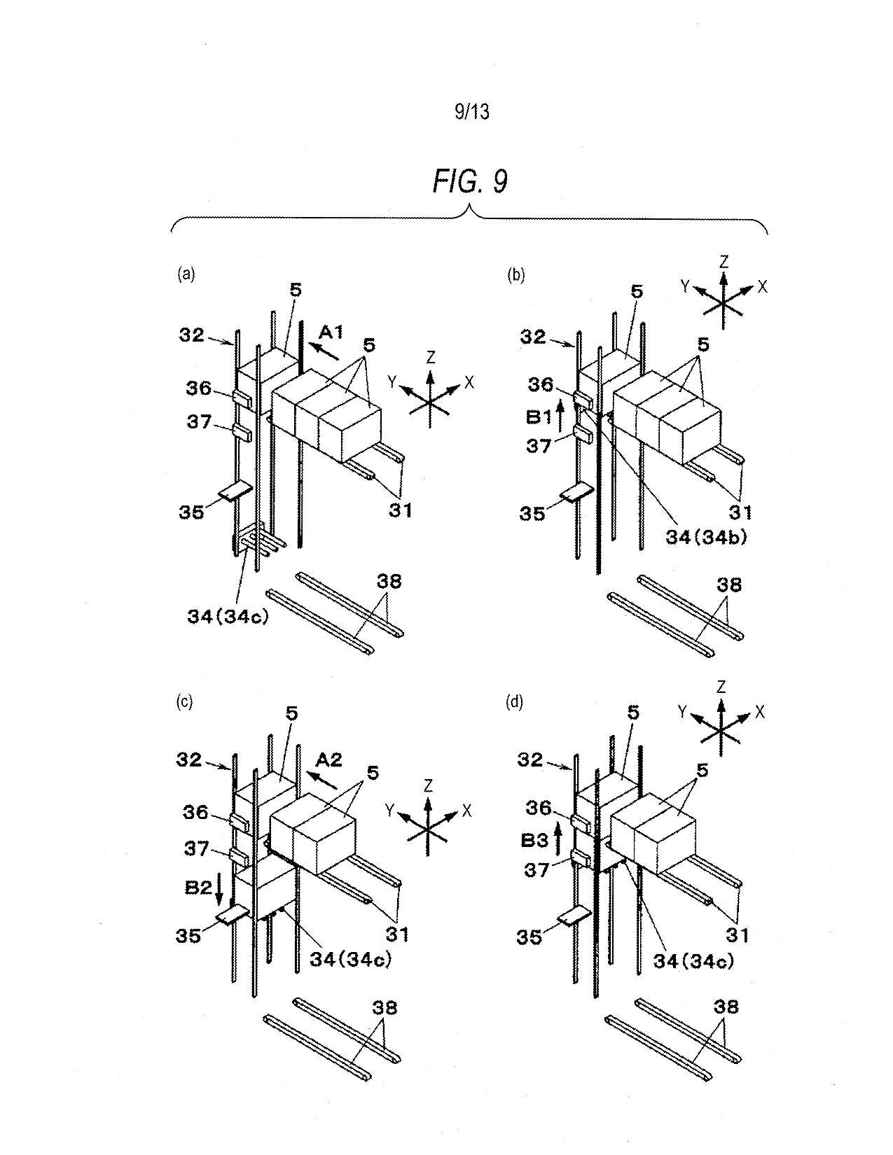

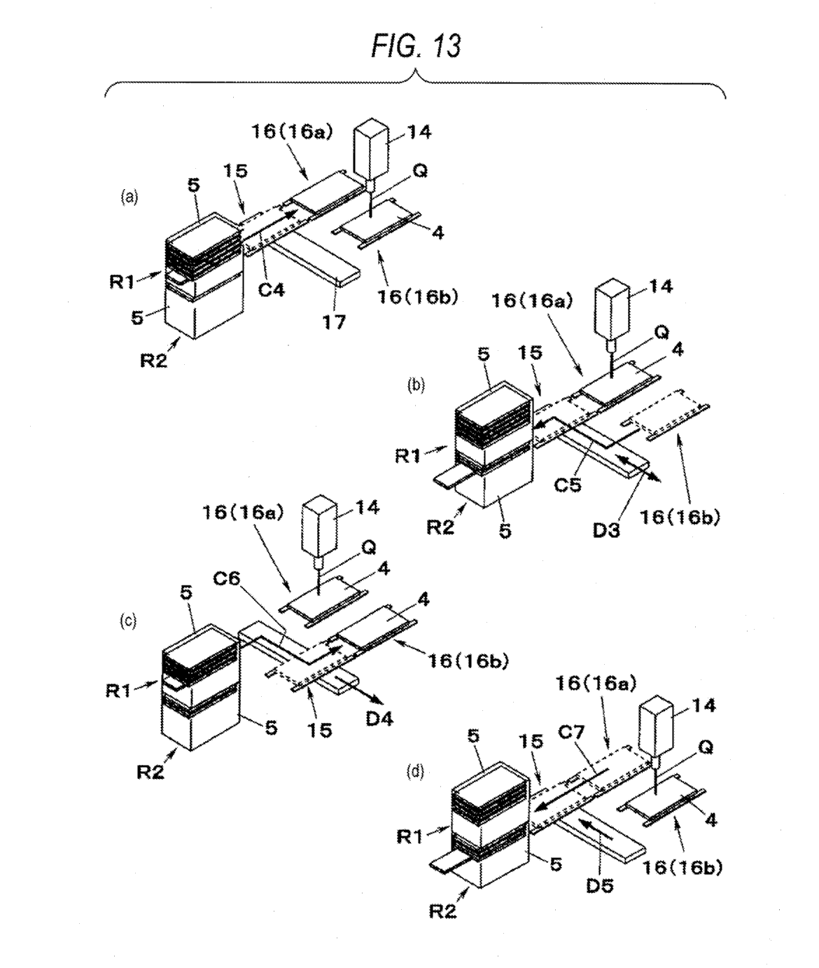

Now, by referring to (a), (b), (c) and (d) in FIG. 9 to (a), (b), (c) and (d) in FIG. 13, a procedure will be described for carrying out a liquid applying operation (a liquid-application method) to the substrate 4 by the liquid-application device 1 having the above-described structure. After one empty magazine 5 is taken in, and then, the magazine 5 for feeding the substrate in which the substrates 4 before the liquid is applied are accommodated is taken in from the magazine taking-in opening 22a of the substrate feed and collecting part 3 by the operator OP, the controller 40 operates the magazine loading conveyor 31 to convey the magazines 5 to the magazine guide 32. Then, when the first empty magazine 5 is located in the rear end part of the magazine loading conveyor 31, the controller locates the empty magazine 5 in the first magazine holding area S1 (an arrow mark A1 shown in (a) in FIG. 9) in the magazine guide 32 by the magazine delivery mechanism 33. Then, the controller clamps the empty magazine 5 by the upper clamper 36 ((a) in FIG. 9).

When the empty magazine 5 located in the magazine holding area S1 is clamped by the upper clamper 36, the controller 40 elevates the elevating part 34b of the magazine elevating machine 34 (an arrow mark B1 shown in (b) in FIG. 9) to support the magazine 5 held in the magazine holding area S1 by the elevating part 34b ((b) in FIG. 9). Then, after the controller releases the held state of the empty magazine 5 by the upper clamper 36, the controller lowers the elevating part 34b of the magazine elevating machine 34 (an arrow mark B2 shown in (c) in FIG. 9). After the controller locates the empty magazine 5 in the second magazine holding area S2 for a lower part thereof), the controller operates the magazine loading conveyor 31 to locate the magazine 5 for feeding the substrate which is located in the rear end part of the magazine loading conveyor 31 in the first magazine holding area S1 in the magazine guide 32 (an arrow mark A2 shown in (c) in FIG. 9). Then, the controller operates the upper clamper 36 to clamp the magazine 5 for feeding the substrate which is located in the first magazine holding area S1 ((c) in FIG. 9).

When the controller 40 clamps the magazine 5 for feeding the substrate located in the first magazine holding area S1 by the upper clamper 36, the controller 40 elevates the empty magazine 5 by the magazine elevating machine 34 (an arrow mark 83 shown in (d) in FIG. 9) so that the empty magazine 5 is allowed to come into contact, from a lower part, with the magazine 5 for feeding the substrate which is located in the first magazine holding area S1, and then, the controller releases the clamped state of the magazine 5 for feeding the substrate by the upper clamper 36 ((d) in FIG. 9). Thus, the magazine 5 for feeding the substrate is located in the substrate feed part R1 and the magazine 5 for collecting the substrate is located in the substrate collecting par R2.

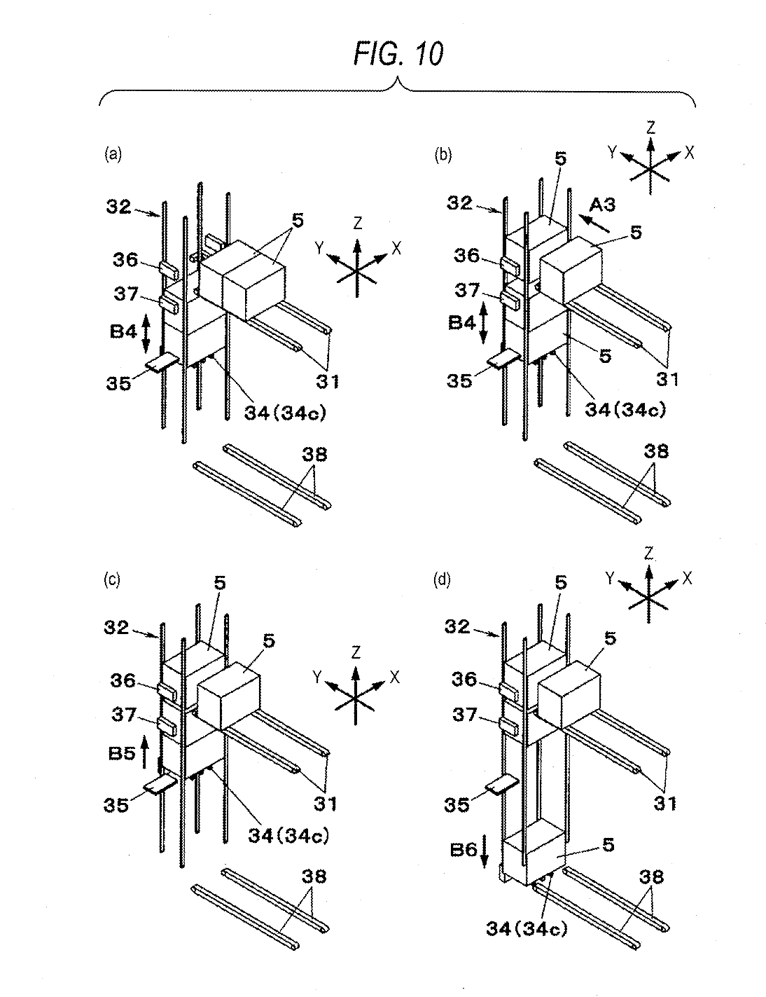

When the controller 40 releases the clamped state of the magazine 5 for feeding the substrate by the upper clamper 36, the controller 40 elevates or lowers the magazine 5 for feeding the substrate in the substrate feed part R1 and the magazine 5 for collecting the substrate in the substrate collecting part R2 at the same time (in an integral state) (arrow marks B4 shown in (a) and (b) in FIG. 10) by the magazine elevating machine 34 to feed the substrate 4 to the main body part 2 (the substrate feeding operation by the substrate push and pull mechanism 35) and collect the substrate 4 from the main body part 2 (the substrate accommodating operation by the substrate push and pull mechanism 35). Further, the controller carries out the applying operation of the liquid Q to the substrate 4 in the main body part 2 in accordance with a below-described procedure.

The feed of the substrate 4 to the main body part 2 and the collecting of the substrate 4 from the main body part 2 are carried out in accordance with the above-described method explained by referring to (a) and (b) in FIG. 6 and (a) and (b) in FIG. 7. When the substrate 4 is fed from the magazine 5 for feeding the substrate, the substrates 4 are preferably pushed out in order from the rack parts 5b located in the lower part of the magazine 5 for feeding the substrate and fed to the main body part 2. In such a way, when the substrate 4 is pushed out from the magazine 5 for feeding the substrate, even if dust or the like falls from the substrate 4 or the magazine 5, the dust can be prevented from adhering to other substrates 4 in the magazine 5 for feeding the substrate.

Further, when the substrate 4 is collected to the magazine 5 for collecting the substrate, the substrates 4 are preferably accommodated in order from the rack parts 5b located in the upper part of the magazine 5 for collecting the substrate. In such a way, when the substrate 4 is pulled to the magazine 5 for collecting the substrate, even if the dust or the like falls from the substrate 4 or the magazine 5, the dust can be prevented from adhering to other substrate 4 in the magazine 5 for collecting the substrate.

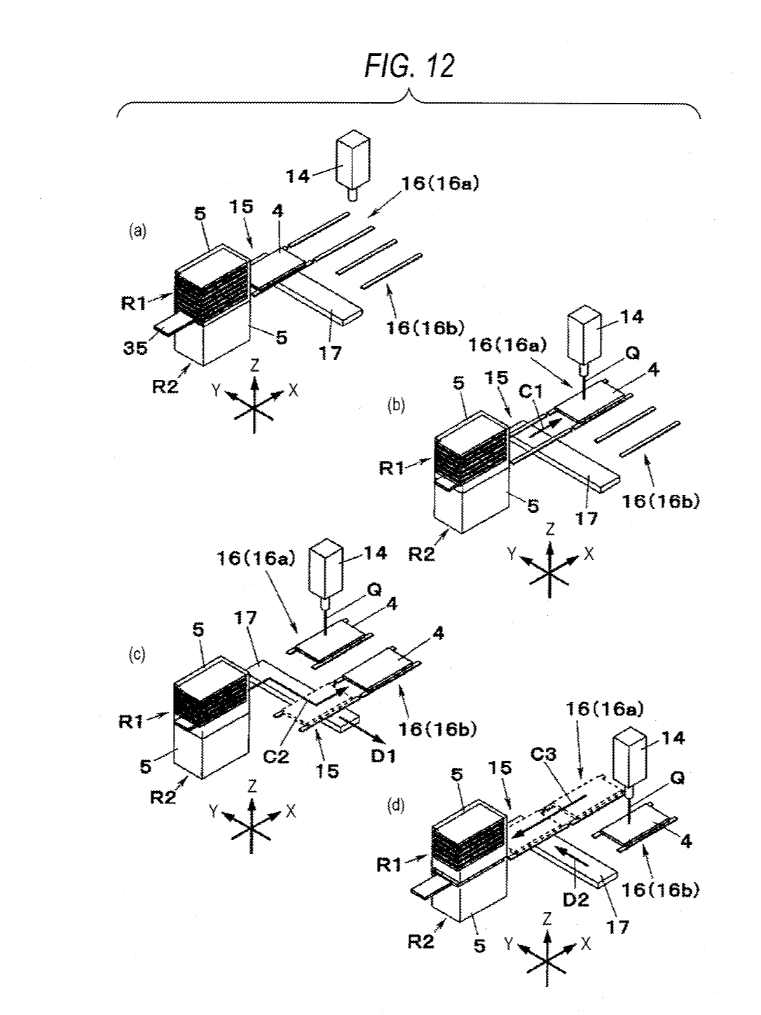

In the applying operation of the liquid Q to the substrate 4 by the main body part 2, the controller 40 receives the substrate 4 pushed out from the magazine 5 for feeding the substrate of the substrate feed part R1 by the receiving conveyor 15 to take out the substrate 4 ((a) in FIG. 12, a substrate taking out step). Then, the controller delivers the received substrate 4 to the rear positioning conveyor 16a (an arrow mark C1 shown in (b) in FIG. 12). Then, the controller operates the rear substrate positioning conveyor 16a to move (position) the substrate 4 to the rear working position ((b) in FIG. 12. a working position moving step).

After the controller 40 moves the substrate 4 to the rear working position, the controller 40 carries out the control of the moving operation of the application head 14 by the application head moving mechanism 13 and the control of the discharging operation of the liquid Q by the application head 14 to carry out the liquid applying operation to the substrate 4 positioned in the rear working operation ((b) in FIG. 12. a liquid applying step).

When the controller 40 starts the liquid applying operation to the substrate 4 positioned in the rear working position by the application head 14, the controller 40 receives the substrate 4 newly pushed out from the magazine 5 for feeding the substrate of the substrate feed part R1 by the receiving conveyor 15 to take out the substrate 4 (a substrate taking out step). Then, the controller moves the receiving conveyor 15 forward by the receiving conveyor moving mechanism 17 (an arrow mark D1 shown in (c) in FIG. 12) to deliver the substrate 4 to the front positioning conveyor 16b (an arrow mark C2 shown in (c) in FIG. 12) and operates the front positioning conveyor 16b to move (position) the substrate 4 to the front working position and allow the substrate 4 to stand by ((c) in FIG. 12. a working position moving step).

After the controller 40 moves the substrate 4 to the front working position, when the liquid applying operation to the substrate 4 positioned in the rear working position is finished, the controller moves the application head 14 to carry out the liquid applying operation to the substrate 4 which is allowed to stand by in the front working position (a liquid applying step). Then, while the controller carries out the liquid applying operation, the controller moves the receiving conveyor 15 rearward (an arrow mark D2 shown in (d) in FIG. 12) to convey the substrate 4 located in the rear working position to the substrate feed and collecting part 3 (an arrow mark C3 shown in (d) in FIG. 12) via the receiving conveyor 15, and accommodates the substrate 4 to which the liquid is applied in the magazine 5 for collecting the substrate of the substrate collecting part R2 ((d) in FIG. 12. a substrate accommodating step).

When the controller 40 accommodates the substrate 4 the liquid applying operation of which is finished in the rear working position in the magazine 5 for collecting the substrate, the controller receives the substrate 4 newly pushed out from the magazine 5 for feeding the substrate of the substrate feed part R1 by the receiving conveyor 15 to take out the substrate 4 (a substrate taking out step), then, delivers the substrate to the rear positioning conveyor 16a via the receiving controller 15 (an arrow mark C4 shown in (a) in FIG. 13) and operates the rear substrate positioning conveyor 16a to move the substrate 4 to the rear working position and allow the substrate 4 to stand by ((a) in FIG. 13. a working position moving step).

After the controller 40 moves the substrate 4 to the rear working position, when the liquid applying operation to the substrate 4 positioned in the front working position is finished by the application head 14, the controller moves the application head 14 to carry out the liquid applying operation to the substrate 4 which is allowed to stand by in the rear working position (a liquid applying step). Then, while the controller carries out the liquid applying operation, the controller moves the receiving conveyor 15 forward and rearward (an arrow mark D3 shown in (b) in FIG. 13) to convey the substrate 4 located in the front working position to the substrate feed and collecting part 3 via the receiving conveyor 15 ((b) in FIG. 13. an arrow mark C5 shown in the drawing) and accommodates the substrate 4 to which the liquid is applied in the magazine 5 for collecting the substrate of the substrate collecting part R2 ((b) in FIG. 13. a substrate accommodating step).

After the controller 40 accommodates the substrate 4 the liquid applying operation of which is finished in the front working position in the magazine 5 for collecting the substrate, the controller receives the substrate 4 newly pushed out from the magazine 5 for feeding the substrate of the substrate feed part R1 by the receiving conveyor 15 to take out the substrate 4(a substrate taking out step), then, moves the receiving conveyor 15 forward (an arrow mark D4 shown in (c) in FIG. 13) and delivers the substrate 4 to the front positioning conveyor 16b (an arrow mark C6 shown in (c) in FIG. 13). Then, the controller operates the front substrate positioning conveyor 16b to move the substrate 4 to the front working position and allow the substrate 4 to stand by ((c) in FIG. 13. a working position moving step).

When the controller 40 finishes the liquid applying operation to the substrate 4 positioned in the rear working position after the controller moves the substrate 4 to the front working position, the controller moves the application head 14 to carry out the liquid applying operation to the substrate 4 which is allowed to stand by in the front working position (a liquid applying step). Then, while the controller carries out the liquid applying operation, the controller moves the receiving conveyor 15 rearward (an arrow mark D5 shown in (d) in FIG. 13) to convey the substrate 4 located in the rear working position to the substrate feed and collecting part 3 via the receiving conveyor 15 ((d) in FIG. 13. an arrow mark C7 shown in the drawing) and accommodates the substrate 4 to which the liquid is applied in the magazine 5 for collecting the substrate of the substrate collecting part R2 ((d) in FIG. 13. a substrate accommodating step). Subsequently, the controller repeats the steps shown in (a), (b), (c), (d), (a) . . . in FIG. 13

As described above, the controller 40 elevates or lowers the magazine 5 for feeding the substrate of the substrate feed part R1 and the magazine 5 for collecting the substrate of the substrate collecting part R2 at the same time (in the integral state) to feed to substrate 4 to the main body part 2 and recover the substrate 4 from the main body part 2, and further, carries out the applying operation of the liquid Q to the substrate 4 in the main body part 2. During that time, the controller operates the magazine loading conveyor 31 and the magazine delivery mechanism 33 to locate the magazine 5 for feeding the substrate provided in the top of the magazine loading conveyor 31 in the first magazine holding area S1 in the magazine guide 32 (an arrow mark A3 shown in (b) in FIG. 10). Then, the controller operates the upper clamper 36 to clamp the magazine 5 for feeding the substrate located in the first magazine holding area S1 ((b) in FIG. 10).

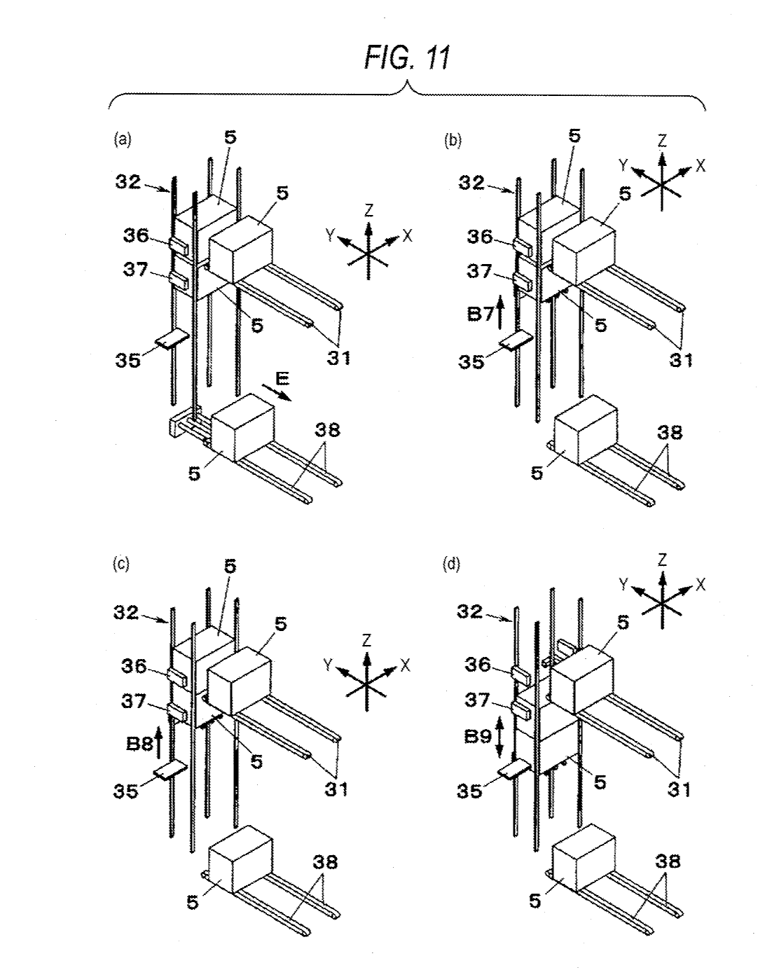

After the controller clamps the magazine 5 for feeding the substrate located in the magazine holding area S1 by the upper clamper 36, when the liquid applying operation to the substrate 4 progresses so that the magazine 5 for feeding the substrate installed in the substrate feed part R1 is emptied, the emptied magazine 5 for feeding the substrate of the substrate feed part R1 and the magazine 5 for collecting the substrate of the substrate collecting part R2 in which the substrates 4 after the liquid is applied are accommodated are elevated at the same time (in the integral state) (an arrow mark 85 shown in (c) in FIG. 10) to locate the magazine 5 for feeding the substrate which is emptied in the second magazine holding area S2. Then, the controller 40 clamps the emptied magazine 5 for feeding the substrate by the lower clamper 37 ((c) in FIG. 10). Then, the controller 40 lowers only the magazine 5 for collecting the substrate of the substrate collecting part R2 (an arrow mark 86 shown in (d) in FIG. 10) by the magazine elevating machine 34 and mounts the magazine 5 for collecting the substrate on the unloading conveyor 38 to convey the magazine 5 for collecting the substrate forward by the magazine unloading conveyor 38 ((a) in FIG. 11. an arrow mark E shown in the drawing).

When the controller 40 conveys the magazine 5 for collecting the substrate forward by the magazine unloading conveyor 38, the controller elevates the elevating part 34b of the magazine elevating machine 34 (an arrow mark B7 shown in (b) in FIG. 11) to support the magazine 5 held in the magazine holding area S2 by the elevating part 34b ((b) in FIG. 11). Then, the controller releases the held state of the emptied magazine 5 by the lower clamper 37 and elevates the elevating part 34b of the magazine elevating machine 34 (an arrow mark B8 shown in (c) in FIG. 11) to allow an upper surface of the emptied magazine 5 to come into contact with a lower surface of the magazine 5 for feeding the substrate held in the first magazine holding area S1. Then, the controller releases the clamped state of the magazine 5 for feeding the substrate located in the first magazine holding area S1 by the upper clamper 36 ((c) in FIG. 11).

Thus, since the magazine 5 for feeding the substrate is located in the substrate feed part R1 and the magazine 5 for collecting the substrate is located in the substrate collecting part R2, the controller subsequently by the magazine elevating machine 34 elevates or lowers the magazine 5 for feeding the substrate of the substrate feed part R1 and the magazine 5 for collecting the substrate of the substrate collecting part R2 at the same time (in the integral state) (an arrow mark B9 shown in (d) in FIG. 11) to feed the substrate 4 to the main body part 2 and collect the substrate 4 from the main body part 2, and further carries out the applying operation of the liquid Q to the substrate 4 in the main body part 2. Then, the controller subsequently repeats the steps of (b), (c), (d) in FIG. 10, (a), (b), (c), (d) in FIG. 11, and (b) in FIG. 10 . . . .

In the above-described series of steps, the operator OP suitably takes in the magazine 5 for feeding the substrate to the magazine loading conveyor 31 from the magazine taking-in opening 22a and takes out the magazine 5 for collecting the substrate conveyed to the magazine taking-out opening 22b by the magazine unloading conveyor 38.

As described above, the liquid-application device 1 in the present exemplary embodiment includes the substrate feed part R1 where the magazine 5 for feeding the substrate is installed in which the substrates 4 before the liquid Q is applied are accommodated, the application head 14 which applies the liquid Q to the substrate 4 taken out from the magazine 5 for feeding the substrate installed in the substrate feed part R1 and moved to the working position and the substrate collecting part R2 where the magazine 5 for collecting the substrate is installed in which the substrates 4 with the liquid Q applied by the application head 14 are accommodated. The magazine moving unit which removes the magazine 5 for collecting the substrate from the substrate collecting part R2, when the magazine 5 for feeding the substrate installed in the substrate feed part R1 is exchanged for a new magazine 5 for feeding the substrate, moves the magazine 5 for feeding the substrate that is installed in the substrate feed part R1 so far to the substrate collecting part R2 as a subsequently used magazine 5 for collecting the substrate, and then, installs the new magazine 5 for feeding the substrate in the substrate feed part, is provided.

The liquid-application method by the liquid-application device 1 includes the step (the above-described substrate taking out step, the working position moving step) in which the substrate before the liquid Q is applied is taken out from the magazine 5 for the substrate installed in the substrate feed part R1 and moved to the working position, the step (the above-described liquid applying step) in which the liquid Q is applied to the substrate moved to the working position and the step (the above-described substrate accommodating step) in which the substrate 4 to which the liquid Q is applied is moved from the working position to accommodate the substrate in the magazine 5 for collecting the substrate installed in the substrate collecting part R2. When the magazine 5 for feeding the substrate installed in the substrate feed part R1 is exchanged for a new magazine 5 for feeding the substrate, the magazine 5 for collecting the substrate is removed from the substrate collecting part R2, the magazine 5 for feeding the substrate that is installed in the substrate feed part R1 so far is moved to the substrate collecting part R2 as a subsequently used magazine 5 for collecting the substrate, and then, the new magazine 5 for feeding the substrate is installed in the substrate feed part.

In the liquid-application device 1 and the liquid-application method of the present exemplary embodiment, when the magazine 5 for feeding the substrate installed in the substrate feed part R1 is exchanged for a new magazine 5 for feeding the substrate, the magazine 5 for collecting the substrate is removed from the substrate collecting part R2, the magazine 5 for feeding the substrate that is installed in the substrate feed part R1 so far is moved to the substrate collecting part as a subsequently used magazine 5 for collecting the substrate, and then, the new magazine 5 for feeding the substrate is installed in the substrate feed part. Accordingly, since the magazine 5 for feeding the substrate that is installed in the substrate feed part R1 so far is used as the magazine 5 for collecting the substrate, the work for carrying the magazine 5 for feeding the substrate which is installed in the substrate feed part R1 so far outside the liquid application device 1 and the work for carrying the new magazine 5 for collecting the substrate to the liquid application device 1 are not necessary. Thus, the number of setting steps of empty magazines necessary for a usual loader and un-loader type can be reduced, so that a production cost can be the more reduced.

In the above-described exemplary embodiment, an example is shown that the magazine 5 for feeding the substrate of the substrate feed part R1 and the magazine 5 for collecting the substrate of the substrate collecting part R2 are arranged and located in parallel in the vertical direction under a state that the magazine 5 for the feeding the substrate of the substrate feed part R1 is mounted on the magazine 5 for collecting the substrate of the substrate collecting part R2. However, depending on the arrangement of the magazine loading conveyor 31 and the magazine unloading conveyor 38, the magazine 5 for feeding the substrate of the substrate feed part R1 and the magazine 5 for collecting the substrate of the substrate collecting part R2 may be arranged and located in parallel in the vertical direction under a state that the magazine 5 for collecting the substrate of the substrate collecting part R2 is mounted on the magazine 5 for feeding the substrate of the substrate feed part R1. The magazine 5 for feeding the substrate of the substrate feed part R1 and the magazine 5 for collecting the substrate of the substrate collecting part R2 may be arranged and located in parallel in the vertical direction under a state that one is mounted on the other. Further, a case that the magazine 5 for feeding the substrate installed in the substrate feed part R1 is replaced by the new magazine 5 for feeding the substrate is not necessarily limited to a case that the substrates 4 in the magazine 5 for feeding the substrate (the substrates 4 before the liquid is applied) are exhausted.

This application is based is based on Japanese Patent Application (JPA No. 2011-187211) filed on Aug. 30, 2011 and contents thereof are incorporated herein as a reference.

### INDUSTRIAL APPLICABILITY

The liquid application device and the liquid-application method are provided which can simplify the moving mechanism of the magazine and reduce a production cost.

### DESCRIPTION OF REFERENCE NUMERALS AND SIGNS

1 liquid-application device
4 substrate
5 magazine
14 application head
21 magazine moving mechanism (magazine moving unit)
R1 substrate feed part
R2 substrate collecting part
Q liquid

1. A liquid application device, comprising:
a substrate feed part where a magazine for feeding a substrate is installed, the magazine for feeding the substrate accommodating the substrates before a liquid-application is applied;
an application head which applies the liquid-application to the substrate taken out from the magazine for feeding the substrate installed in the substrate feed part and moved to a working position and a substrate collecting part where a magazine for collecting the substrate is installed, the magazine for feeding the substrate which accommodates the substrates with the liquid-application applied by the application head; and
a magazine moving unit which removes the magazine for collecting the substrate from the substrate collecting part, when the magazine for feeding the substrate installed in the substrate feed part is exchanged for a new magazine for feeding the substrate, moves the magazine for feeding the substrate that is installed in the substrate feed part so far to the substrate collecting part as a subsequently used magazine for collecting the substrate, and then, installs the new magazine for feeding the substrate in the substrate feed part.

2. A liquid-application method comprising:
a step in which a substrate before a liquid is applied is taken out from a magazine for feeding the substrate installed in a substrate feed part and moved to a working position;
a step in which the liquid is applied to the substrate moved to the working position, and a step in which the substrate to which the liquid is applied is moved from the working position to accommodate the substrate in a magazine for collecting the substrate installed in a substrate collecting part;
wherein, when the magazine for feeding the substrate installed in the substrate feed part is exchanged for a new magazine for feeding the substrate, the magazine for collecting the substrate is removed from the substrate collecting part, the magazine for feeding the substrate that is installed in the substrate feed part so far is moved to the substrate collecting part as a subsequently used magazine for collecting the substrate, and then, the new magazine for feeding the substrate is installed in the substrate feed part.
